(19) United States
(12) Patent Application Publication
(10) Pub. No.: US 2007/0254665 A1
(43) Pub. Date: Nov. 1, 2007

(54) Wireless Switches with JTAG Emulators

(75) Inventors: Edward Geiger, San Martin, CA (US); Nicolas Dade, Santa Cruz, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/742,231

(22) Filed: Apr. 30, 2007

Related U.S. Application Data
(60) Provisional application No. 60/797,018, filed on May 1, 2006.

(51) Int. Cl. H04B 1/40

(52) U.S. Cl. 455/436

(57) ABSTRACT

A wireless switch includes a multi-core processor comprising a first core and a second core, and a JTAG emulator coupled to the first core and the second core. The JTAG application of the first core is adapted to debug the second core via the JTAG emulator.

### CROSS-REFERENCES TO RELATED APPLICATIONS

This application claims the benefit of U.S. provisional patent application Ser. No. 60/797,018, filed May 1, 2006.

### FIELD OF THE INVENTION

The present invention generally relates to wireless switches, and more particularly relates to wireless switches with JTAG emulators.

### BACKGROUND OF THE INVENTION

There has been a dramatic increase in demand for mobile connectivity solutions utilizing various wireless components and WLANs. This generally involves the use of wireless access points that communicate with mobile devices using one or more RF channels. A WLAN may operate in accordance with one or more of the IEEE 802.11 standards.

WLANs can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless switches generally function as network interfaces between wireless access devices and a traditional computer network, such as a local area network (LAN).

Wireless switches, for example, are now commonly used to provide access to digital networks (such as the Internet or a corporate/campus network) via various wireless access points. Typically, a wireless switch remains in communication with one or more wireless access points via the network to facilitate wireless communications between the access point and digital network. One example of a wireless switch infrastructure based upon products available from SYMBOL TECHNOLOGIES INC. of San Jose, Calif. is shown in United States Patent Publication No. 2005/0058087A1.

Wireless switches may require maintenance and debugging. The conventional mechanism for performing maintenance and/or debugging functions require a technician to attach and run diagnostics with a JTAG emulator and associated processing system. JTAG, an acroynm for Joint Test Action Group, refers to the IEEE 1149.1 standard entitled Standard Test Access Port and Boundary-Scan Architecture used for testing printed circuit boards, blocks of integrated circuits, embedded systems, and in this case, wireless switches. These tests are costly and time consuming because the technician must physically intact with the wireless switch to run the diagnostics, typically with a JTAG emulator housed in a separate computer provided by the technician.

Accordingly, it is desirable to provide wireless switches with JTAG emulators that enable a remote technician to perform maintenance and debugging functions. In addition, it is desirable to provide methods for performing diagnostic testing on wireless switches. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and wherein:

FIG. 1 is a conceptual overview of a wireless network in accordance with an exemplary embodiment of the present invention;

FIG. 2 is a schematic representation of a wireless switch of the wireless network of FIG. 1; and

FIG. 3 is a schematic representation of a memory in the wireless switch of FIG. 2.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely exemplary applications for the invention.

For the sake of brevity, conventional techniques related to WLANs, signal processing, data transmission, signaling, network control, the 802.3 and 802.11 families of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

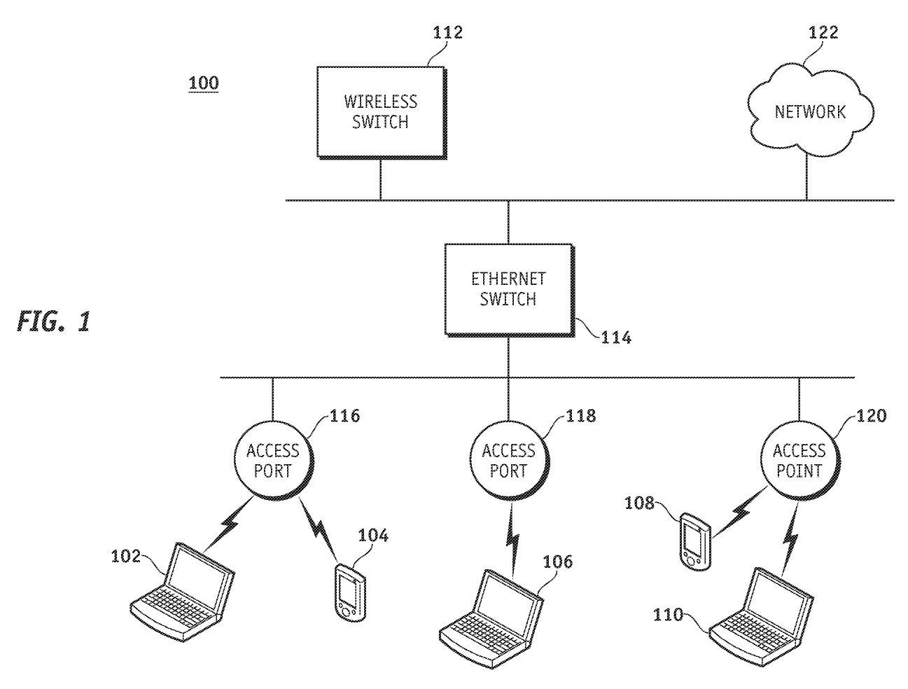

FIG. 1 is a schematic representation of a computer network 100 configured in accordance with an example embodiment of the invention. In this example, computer network 100 includes a WLAN. The computer network 100 generally includes wireless clients (identified by reference numbers 102, 104, 106, 108, and 110), a wireless switch 112, an Ethernet switch 114, and a number of wireless access devices (identified by reference numbers 116, 118, and 120). The computer network 100 may also include or communicate with any number of additional network components, such as a traditional local area network (LAN). In FIG. 1, such additional network components are generally identified by reference number 122. A practical embodiment can have any number of wireless switches, each supporting any number of wireless access devices, and each wireless access device supporting any number of wireless clients. Indeed, the topology and configuration of the computer network 100 can vary to suit the needs of the particular application and FIG. 1 is not intended to limit the application or scope of the invention in any way.

In this example, the wireless access devices 116, 118 are realized as wireless access ports, which are “thin” devices that rely on the network intelligence and management functions provided by the wireless switch 112, while wireless access device 120 is realized as a wireless access point, which is a “thick” device having the network intelligence and processing power integrated therein. Thus, the wireless access device 120 need not rely upon the wireless switch 112 for operation. Wireless access ports having conventional features that can be incorporated into the wireless access devices 116, 118, and wireless access points having conventional features that can be incorporated into the wireless access device 120 are available from Symbol Technologies, Inc. Briefly, a wireless access device as described herein is suitably configured to receive data from wireless clients over wireless links. Once that data is captured by the wireless access device, the data can be processed for communication within the computer network 100. For example, the data can be encapsulated into a packet format compliant with a suitable data communication protocol. In the example embodiment, data is routed within the computer network 100 using conventional Ethernet 802.3 addressing (including standard Ethernet destination and source packet addresses).

The wireless switch 112 is coupled to the Ethernet switch 114, which is in turn coupled to the wireless access devices 116, 118, 120. In practice, the wireless switch 112 communicates with the wireless access devices 116, 118 via the Ethernet switch 114. A given wireless switch can support any number of wireless access devices, i.e., one or more wireless access devices can be concurrently adopted by a single wireless switch (in one embodiment, a wireless access device can be adopted by only one wireless switch at a time). The wireless clients are wireless devices that can physically move around the computer network 100 and communicate with the network components 122 via the wireless access devices 116, 118, 120.

The wireless switch 112 may include various advantageous features. For example, the wireless switch 112 may utilize a field programmable gate array (FPGA) to perform the switching code. The wireless switch 112 may also be suitably configured to accept a CompactFlash card or other portable nonvolatile memory device to assist with reloading the wireless switch 112 after initial switch activation. Moreover, a USB port can be included on the exterior of the wireless switch 112 for interfacing with one or more USB devices. In accordance with another feature of the wireless switch 112, booting is initiated via a NAND switch rather than a NOR switch as used in existing wireless switch devices. The wireless switch can include a main processing element such as a motherboard and an additional, optional processing element such as a daughterboard.

The wireless switch 112 can include a physical housing that surrounds and protects the components of the wireless switch 112. A number of features, elements, and components of the wireless switch 112 may be accessible from the exterior of housing. In this example, most of these accessible and/or viewable features are located at the front face panel of wireless switch 112. In this regard, wireless switch 112 may include, without limitation: one or more system LED lights; an out-of-band management port; one or more USB ports; one or more memory card slots; and various Ethernet connectors, jacks, or ports.

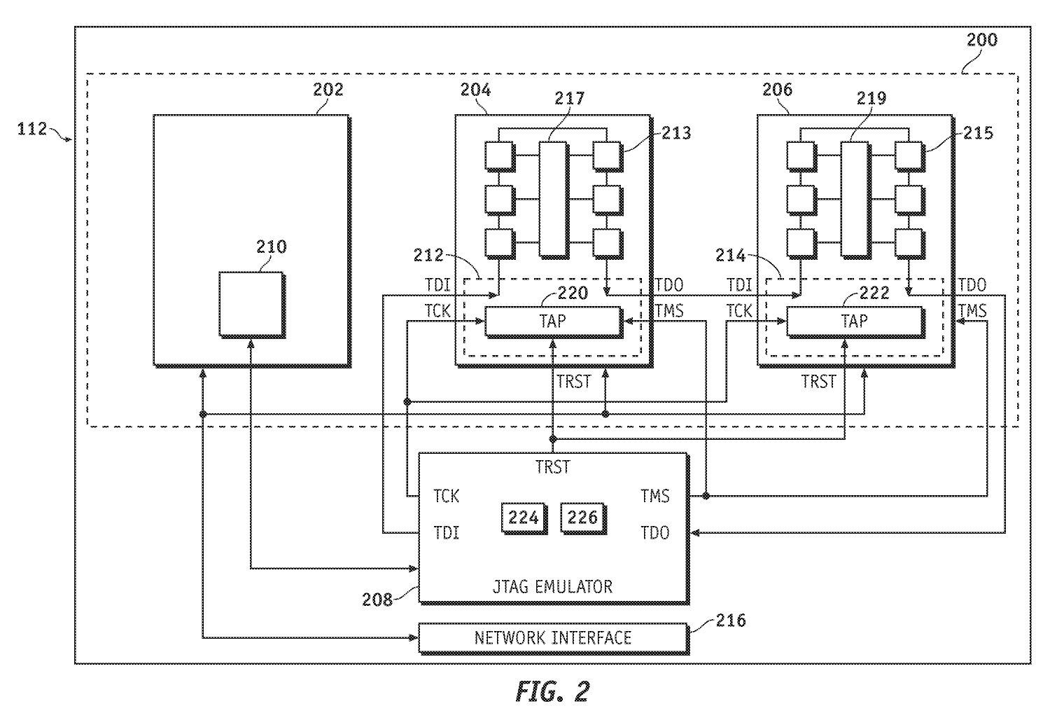

FIG. 2 is a schematic representation of the wireless switch 112 configured in accordance with an embodiment of the invention. A practical embodiment of the wireless switch 112 will include components and elements configured to support known or conventional operating features that need not be described in detail herein. Accordingly, FIG. 2 is a simplified illustration that omits elements that might otherwise be found inside the wireless switch 112.

The wireless switch 112 has an exemplary implementation of a multi-core data processing system 200 that includes a plurality of cores 202, 204, 206. The multi-core processing system 200 effectively combines the circuitry of two or more processors onto a common semiconductor die. In one embodiment, the core 202 is a control core 202 and the cores 204, 206 are data handling cores 204, 206, although other configurations are possible. The control core 202 typically executes the base operating system (e.g. LINUX or the like), whereas the data handling cores 204, 206 execute the various handler logic. By dividing the data handling function from the operating system function, the overall throughput of system 200 can be markedly improved in many embodiments. Although three cores 202, 204, 206 are illustrated in FIG. 2, a greater or fewer number of cores are possible. In one embodiment, eight cores are provided.

As referenced above, the processing system 200 and/or the wireless switch 112 can include additional components (not shown), such as a suitable amount of memory, an external and internal interfaces, and one or more peripheral or accessory components. The peripheral or accessory components can include one or more of the following: an intermediate processor, a boot device selector, an additional amount of memory, a USB interface that includes a USB host controller and at least one USB port, a suitable amount of NAND flash memory, a suitable amount of NOR flash memory, and a portable flash memory card port. These and other elements may be interconnected together using a bus or any suitable interconnection arrangement. In this exemplary embodiment, all of the components are located within a single housing, which represents the physical package for the wireless switch 112.

The cores 202, 204, 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. The processing system 200 may also be implemented as a combination of computing devices, e.g., a combination of a digital signal processor and a microprocessor, a plurality of microprocessors, one or more microprocessors in conjunction with a digital signal processor core, or any other such configuration.

As illustrated, the data handling cores 204, 206 each include respective data logic 217, 219 and a plurality of data registers 213, 215. As discussed in further detail below, the data handling cores 204, 206 further include respective JTAG interfaces 212, 214 to clock data in and out of the registers 213, 215 to perform diagnostic tests on the data logic 217, 219.

In accordance with one exemplary embodiment, the wireless switch 112 includes a JTAG emulator 208 coupled to and controlled by a JTAG application 210 in the control core 202. The JTAG emulator 208 is further coupled to the JTAG interfaces 212, 214 of the data handling cores 204, 206. The JTAG emulator 208 may be embodied as a field programmable gate array (FPGA) programmed with the appropriate source code. The JTAG emulator 208 can further include a bit counter 224 and memory 226. Accordingly, as discussed herein, the control core 202 can control the debugging of the two data handling cores 204, 206, although in other embodiments, it can be appreciated that software can be provided on one or both of the other, data handling cores 204, 206 to debug the control core 202. In general, exemplary embodiments of the present invention enable a user to halt a boot process of a respective data handling core 204, 206 in order to enter a diagnostic mode, thereby allowing advanced troubleshooting by the control core 202 and the JTAG emulator 208, as discussed in further detail below. In other words, as a general example, exemplary embodiments of the present invention allows a programmer in San Jose or India to login to a problem wireless switch 112 in Texas, launch the remote JTAG emulator application 210, trace the code, and identify problems. The code can then be fixed, re-compiled, and a new NAND image can then be downloaded over the network via the network interface 216 and the wireless switch 112 re-booted. The user can then re-launch the JTAG application 210 and verify that the modified code was successful.

The JTAG interfaces 212, 214 and JTAG emulator 208 are coupled together by the following five lines: a test-reset (TRST) line; a test clock (TCK) line; a test mode select (TMS) line; a test data in (TDI) line; and a test data out (TDO) line. Generally, and as discussed in further detail below, the TRST line initializes and disables the JTAG interface 212, 214 of the cores 204, 206 to be tested. The TCK line controls the timing of the JTAG interface 212, 214 independently from any system clocks. The TMS line selects the test mode in accordance with the JTAG standard. The TDI lines supplies data to the registers 213, 215 of the cores 204, 206, and the TDO line receives the data from the registers 213, 215 of the cores 204, 206. Those of ordinary skill in the art will appreciate that additional, optional signals may be implemented, for example, to allow communication with the devices of particular manufacturers, depending on which functions have been implemented in the wireless switch 112. Moreover, additional registers (not shown) can be provided in the data handling core 204, 206 such as, for example, bypass, user, and instruction registers.

In the illustrated embodiment, the JTAG emulator 208 is coupled to the TRST, TCK and TMS lines of a respective Test Action Port (TAP) controller of each JTAG interface 212, 214 in parallel and is coupled to the TDO from one data handling core 204, 206 to the TDI of the next data handling core 204, 206 in a single loop. In an alternate embodiment, the JTAG emulator 208 can be individually coupled to the JTAG interface 212, 214 of each data handling core 204, 206.

As noted above, exemplary embodiments of the present invention enable a user to remotely log on to the wireless switch 112 via, for example, the network interface 216. The network interface 216 can be a 10/100M Ethernet out of band management port. The user interacts with the control core 202 and can initiate the launching of the JTAG application 210 to control the JTAG emulator 208 and debug one or both of the cores 204, 206.

During the debugging process, the JTAG application 210 of the control core 202 loads a predetermined string of data bits into registers of the JTAG emulator 208. The JTAG emulator 208 then manipulates the data bits into the registers 213, 215 of the JTAG interfaces 212, 214 via the TDI lines and reads the resulting data from the registers 213, 215 from the TDO lines. As such, the registers 213, 215 form a scan path between the TDI line and the TDO line. During normal operation, input and output signals pass through the registers 213, 215 from the data logic 217, 219. However, when the JTAG mode is initiated by the JTAG emulator 208 and the JTAG application 210, the registers 213, 215 are controlled in such a way that test stimulus can be shifted into the registers 213, 215 by the TDI line and captured as resulting data from the registers 213, 215 by the TDO line. The resulting data can be provided to the control core 202 and the JTAG application 210, and interpreted by a technician to diagnose any problems with one or more of the data handling cores 204, 206.

One exemplary embodiment of a control scheme for loading the data bits into the registers 213, 215 is illustrated in the following table and described after the table.

TABLE 1
JTAG Interface Control 0x60

| | | | |
|---|---|---|---|
| 0 | R/W | JTAG TCLK 1 = TCLK high, 0 = TCLK low | 1h |
| 1 | R/W | JTAG TDI 1 = TDI high, 0 = TDI low | 1h |
| 2 | R/W | JTAG TMS 1 = TMS high, 0 = TMS low | 1h |
| 3 | R/W | JTAG TRST 1 = TRST high, | 0h |
| | | 0 = TRST low | |
| 4 | R/W | JTAG Bits Enable 1 = enable, | 0h |
| | | 0 = disable | |
| 5 | R/W | JTAG Emulator Int Mask | 0h |
| | | 1 = Interrupt enabled, 0 = disabled | |
| 6 | R | JTAG Emulator Int 1 = JTAG_DINT | 0h |
| | | asserted, 0 = Not asserted | |
| 7 | R | JTAG Emulator TRST Status | 0h |
| | | 1 = high, 0 = low | |
| 8 | R | TDO line 1 = High, 0 = low | 1h |
| 11–9 | R | Reserved | 0h |
| 12 | R/W | JTAG Read/Write 1 = Operation | 0h |
| | | Running 0 = idle | |
| 13 | R/W | JTAG Read/Write Done 1 = Operation | 0h |
| | | Complete 0 = Clear | |
| 14 | R/W | JTAG Interrupt Mask 1 = enable, | 0h |
| | | 0 = Disable | |
| 15 | R | Reserved | 0h |

Bit 0 (JTAG TCLK) is a bit used to drive the TCLK line into the JTAG interface 212, 214 of the respective data handling core 204, 206. This line is normally tri-stated (with a pull up 10k) from the JTAG emulator 208 and a zero in this register pulls down the TCLK line. Setting this line to a one tri-states this signal.

Bit 1 (JTAG TDI) is a bit used to drive the TDI line into the JTAG interface 212, 214 of the respective data handling core 204, 206. This line is normally tri-stated (with a pull up 10k) from the JTAG emulator 208 and a zero in this register pulls down the TDI line. Setting this line to a one tri-states this signal.

Bit 2 (JTAG TMS) is a bit used to drive the TMS line into the JTAG interface 212, 214 of the respective data handling core 204, 206. This line is normally tri-stated (with a pull up 10k) from the FPGA and a zero in this register pulls down the TMS line. Setting this line to a one tri-states this signal.

Bit 3 (JTAG TRST) is a bit used to drive the TRST line into the JTAG interface 212, 214 of the respective data handling core 204, 206. This line is normally driven low (with a pull down 10k) from the JTAG emulator 208 and a zero in this register drives the TRST low. Setting this line to a one drives the TRST line high and causes a JTAG TRST to occur.

Bit 4 (JTAG Bit Enable) is a bit that enables the values for TMS, TCK, and TDI in this register to be driven on particular pins of the cores 204, 206. This bit can be over-ridden when the automated function is exercised.

Bit 5 (JTAG Emulator INT Mask) is a bit that enables the JTAG Interrupt. Setting this bit will generate an interrupt to the respective core 204, 206 when the JTAG Emulator INT is active and the global interrupt logic is enabled. Clearing this bit disables the JTAG Interrupt.

Bit 6 (JTAG Emulator INT) is a bit that is set when the JTAG Interrupt from the JTAG emulator 208 is active. This bit returns to zero when the emulator interrupt is removed. Bit 7 (Emulator JTRST) is a bit that shows the state of the Emulator JTRST line. Bit 8 (Core TDO) is a bit that shows the state of the JTDO line.

Bit 12 (JTAG Read/Write) is a bit that enables the JTAG emulator 208 to automatically read and write to the registers 213, 215 using a serial interface. Setting this bit starts the clocking out of data from JTAG memory 226 on the JTAG emulator 208 and at the same time clocking data into JTAG memory 226 on the JTAG emulator 208. The number of bits clocked out is determined by the value in the JTAG count register 224. Generally, once started, this operation can not be stopped.

Bit 13 (JTAG Operation Complete) is a bit set when the JTAG operation is completed. Bit 14 (JTAG Operation Interrupt Mask) is a bit that enables an interrupt for the data handling core 204, 206.

As such, in accordance with the exemplary embodiment described in Table 1, to use the JTAG emulator 208, the user should first set bits 2,1, and 0 low. Next, the JTAG enable bit is set to high which drives the TCLK, TDI and TMS lines. Next, the JTAG TRST bit is set to high, which takes the JTAG interface 212, 214 out of reset and moves it into idle. The user can now drive the TMS, TCLK and TDI lines into the JTAG interface 212, 214 and read the state of the TDO line out with bit 8.

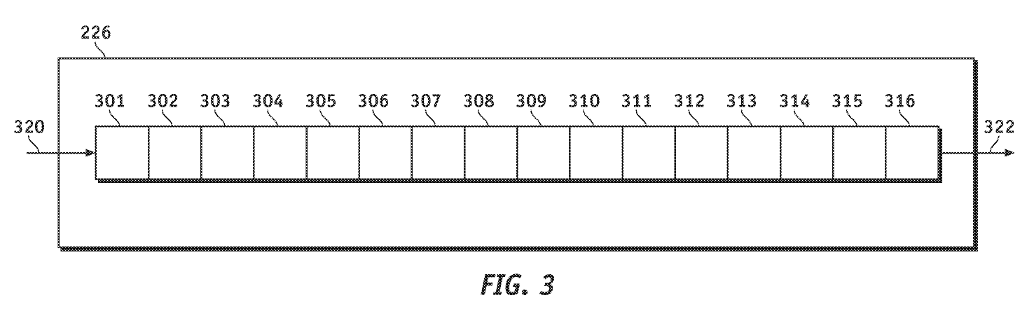

In another exemplary embodiment, a string of bits can be shifted in or out of the JTAG interface 212, 214 using the auto function. To use the auto JTAG function, the JTAG bit count register 224 is loaded with the number of bits to be shifted out and also read into the JTAG emulator 208. FIG. 3 illustrates the JTAG memory 226 in the JTAG emulator 208. In one exemplary embodiment, the JTAG memory 226 includes sixteen memory locations 301-316 that are each sixteen bits long. As such, in this embodiment, the JTAG memory 226 can store 256 bits of data. As illustrated in FIG. 3 by arrows 320 and 322, data can be loaded in the JTAG memory 226, and provided to the data handling cores 204, 206. Data received from the data handling core 204, 206 can be placed back in the JTAG memory 226 of the JTAG emulator 208.

As noted above, the JTAG emulator 208 can further include the JTAG bit counter 224. The JTAG bit counter 224 can include a seven bit register contains the bit count for the JTAG Read/Write. Setting this register to a non-zero value determines the number of bits shifted out of the JTAG memory 226 in and out of the JTAG interfaces 212, 214 and placed back into the JTAG memory 226 of the JTAG emulator 208. The JTAG bit counter 224 determines the number of bits written and read into this JTAG memory 226.

Accordingly, exemplary embodiments of the present invention provide a remote JTAG emulator 208 that enable switch management tools that do not require direct, on-site intervention by a technician. Embodiments of the present invention additionally provide a remote JTAG emulator that is integrated into a switch that enables diagnosis and debugging of the cores 204, 206 of a multi-core processing system 200.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A wireless switch, comprising:
a multi-core processor comprising a first core and a second core, wherein the first core includes a JTAG application and the second core includes a JTAG interface; and
a JTAG emulator coupled to the first core and the second core, wherein the JTAG application of the first core is adapted to debug the second core via the JTAG emulator.

2. The wireless switch of claim 1, wherein the JTAG emulator is an FPGA.

3. The wireless switch of claim 1, wherein the multi-core processor includes three cores.

4. The wireless switch of claim 1, wherein the first core is a control core and the second core is a data handling core.

5. The wireless switch of claim 1, wherein the JTAG emulator includes a memory for receiving test data for debugging the second core.

6. The wireless switch of claim 5, wherein the JTAG emulator includes a bit counter for controlling the test data in and out of the memory.

7. The wireless switch of claim 1, further comprising a network interface coupled to the multi-core processor.

8. The wireless switch of claim 7, wherein the network interface is an Ethernet out of band management port.

9. The wireless switch of claim 1, wherein the JTAG interface includes inputs for test data in (TDI), test clock (TCK), test-reset (TRST), test data out (TDO), and test mode select (TMS) signals.

10. The wireless switch of claim 1, wherein the JTAG interface includes a test action port (TAP) controller.

11. A wireless local area network (WLAN) comprising:
a wireless switch coupled to a network, the wireless switch comprising
a multi-core processor comprising a first core and a second core, wherein the first core includes a JTAG application and the second core includes a JTAG interface, and
a JTAG emulator coupled to the first core and the second core, wherein the JTAG application of the first core is adapted to debug the second core via the JTAG emulator;
a wireless access point coupled to the wireless switch; and
a plurality of wireless access devices configured to receive incoming data packets from the wireless access point.

12. The wireless local area network (WLAN) of claim 11, wherein the JTAG emulator is an FPGA.

13. The wireless local area network (WLAN) of claim 11, wherein the multi-core processor includes three cores.

14. The wireless local area network (WLAN) of claim 11, wherein the first core is a control core and the second core is a data handling core.

15. The wireless local area network (WLAN) of claim 11, wherein the JTAG emulator includes a memory for receiving test data for debugging the second core.

16. The wireless local area network (WLAN) of claim 15, wherein the JTAG emulator includes a bit counter for controlling the test data in and out of the memory.

17. The wireless local area network (WLAN) of claim 11, further comprising a network interface coupled to the multi-core processor.

18. The wireless local area network (WLAN) of claim 17, wherein the network interface is an Ethernet out of band management port.

19. The wireless local area network (WLAN) of claim 11, wherein the JTAG interface includes inputs for test data in (TDI), test clock (TCK), test-reset (TRST), test data out (TDO), and test mode select (TMS) signals.

20. The wireless local area network (WLAN) of claim 11, wherein the JTAG interface includes a test action port (TAP) controller.
